(19) United States
(12) Patent Application Publication
(10) Pub. No.: US 2026/0004551 A1
(43) Pub. Date: Jan. 1, 2026

(54) PROCESSING APPARATUS AND IMAGE PROCESSING APPARATUS

(71) Applicant: CANON KABUSHIKI KAISHA, Tokyo (JP)

(72) Inventor: YUTAKA MURATA, Kanagawa (JP)

(21) Appl. No.: 19/249,108

(22) Filed: Jun. 25, 2025

(30) Foreign Application Priority Data
Jun. 28, 2024 (JP) 2024-105477

(51) Int. Cl. G06V 10/44; G06T 5/20; G06V 10/82

(52) U.S. Cl. CPC G06V 10/44; G06T 5/20; G06V 10/82

(57) ABSTRACT

A processing apparatus has feature plane storage that stores feature plane data. The apparatus has a coefficient storage that stores weight coefficient data. The apparatus has a calculation circuit that performs convolution operation processing using the stored weight coefficient on feature plane data of a feature plane that is supplied by the feature plane storage to the calculation circuit. The apparatus has a parameter storage configured to store a common control parameter for each feature plane group. A plurality of feature planes are grouped into the feature plane group based on commonality of operation processing such that a feature plane to be referred to in the operation processing for calculating the feature plane data of each of the plurality of feature planes is common.

### BACKGROUND

### Field of the Technology

The present disclosure relates to a processing apparatus and an image processing apparatus, and more particularly, to a processing apparatus that performs processing in a neural network.

### Description of the Related Art

Neural networks including convolutional neural networks (CNN) are used for deep learning. Processing in a neural network often includes various kinds of operation processing. For example, processing in a neural network can include convolution processing using feature plane data of various sizes and kernels of various sizes. To perform various kinds of operation processing using hardware (accelerator) that performs processing in the neural network, it is necessary to set the register of the accelerator in accordance with processing contents.

For example, Japanese Patent Laid-Open No. 2008-310524 discloses storing, for each processing node (each convolution operation), an offset address for memory access, an operation execution threshold line count for execution control, and the like in a register (a setting unit and a storage) provided in a unit operation execution unit. Also, Japanese Patent Laid-Open No. 2020-201883 discloses storing, for each processing layer, information such as kernel sizes and the number of feature planes used to control convolution operation processing in a register (holding unit).

### SUMMARY

According to an embodiment, a processing apparatus performs operation processing in a neural network in which a plurality of feature planes are hierarchically connected. The apparatus comprises: feature plane storage that stores feature plane data; a coefficient storage that stores weight coefficient data; a calculation circuit that performs convolution operation processing using the stored weight coefficient on feature plane data of a feature plane that is supplied by the feature plane storage to the calculation circuit; a parameter storage configured to store a common control parameter for each feature plane group, wherein a plurality of feature planes are grouped into the feature plane group based on commonality of operation processing such that a feature plane to be referred to in the operation processing for calculating the feature plane data of each of the plurality of feature planes is common; and a controller configured to control the calculation circuit, the feature plane storage, and the coefficient storage to perform an operation according to the control parameter corresponding to the feature plane group to which the feature plane belongs to calculate the feature plane data of the feature plane.

According to another embodiment, an image processing apparatus comprises: a processing apparatus that performs operation processing in a neural network in which a plurality of feature planes are hierarchically connected, the processing apparatus comprising: feature plane storage that stores feature plane data; a coefficient storage that stores weight coefficient data; a calculation circuit that performs convolution operation processing using the stored weight coefficient on feature plane data of a feature plane that is supplied by the feature plane storage to the calculation circult; a parameter storage configured to store a common control parameter for each feature plane group, wherein a plurality of feature planes are grouped into the feature plane group based on commonality of operation processing such that a feature plane to be referred to in the operation processing for calculating the feature plane data of each of the plurality of feature planes is common; and a controller configured to control the calculation circuit, the feature plane storage, and the coefficient storage to perform an operation according to the control parameter corresponding to the feature plane group to which the feature plane belongs to calculate the feature plane data of the feature plane; and a generation unit configured to generate a result of image processing for the image based on a processing result output from the processing apparatus.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the configuration of a processing apparatus according to an embodiment;

FIGS. 2A and 2B are views each showing an example of a neural network used in the embodiment;

FIG. 3 is a view showing an example of control parameters for each channel;

FIG. 4 is a view showing an example of control parameters according to the embodiment;

FIG. 5 is a view showing an example of the data structure of the control parameters;

FIGS. 6A and 6B are views showing an example of the data structure of the control parameters;

FIG. 7 is a view showing an example of control parameters for each layer;

FIG. 8 is a view showing the procedure of processing corresponding to the control parameters shown in FIG. 7;

FIG. 9 is a view showing an example of resource amounts used by the processing apparatus according to the embodiment;

FIG. 10 is a flowchart of processing performed by the processing apparatus according to the embodiment;

FIGS. 11A and 11B are views each showing an example of the neural network used in the embodiment;

FIG. 12 is a view showing the procedure of processing using the control parameters for each layer; and

FIG. 13 is a view showing an example of the configuration of an image processing apparatus according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In recent years, neural networks have become complex. For example, in some cases, feature planes of different sizes are included in the same layer. Also, in convolution operations of the same layer, the kernel sizes or pooling processing may be different. Furthermore, connection between layers sometimes exists to skip processing.

When applying the method described in Japanese Patent Laid-Open No. 2020-201883 to such a complex neural network, a register is set such that all convolution operations in one layer can be executed. For example, the register is set such that processing according to the maximum feature plane size and the maximum kernel size is performed for a plurality of convolution operations in one layer. In this case, an excessive memory is needed to store feature plane data, and unnecessary product-sum operations are performed. On the other hand, if the register is set for each convolution operation, like the method described in Japanese Patent Laid-Open No. 2008-310524, time needed to set the register is the factor to lower the operation speed.

An embodiment of the present disclosure makes it possible to efficiently perform operation processing using a processing apparatus in a neural network.

### (Configuration of Processing Apparatus)

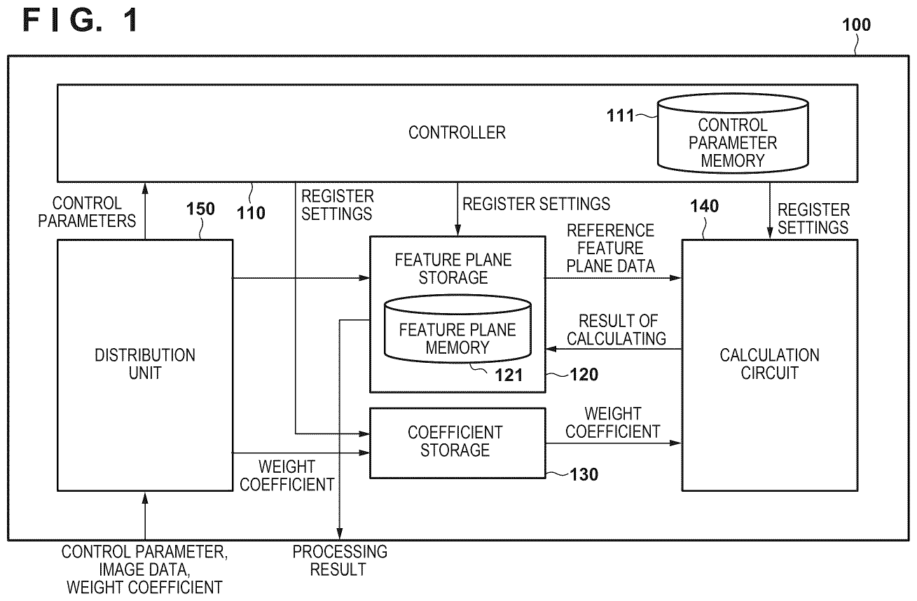

A processing apparatus 100 according to the embodiment will be described with reference to FIG. 1. The processing apparatus 100 performs operation processing in a neural network in which a plurality of feature planes are hierarchically connected. An example of the neural network will be described later. FIG. 1 shows an example of the configuration of the processing apparatus 100. The processing apparatus 100 includes a controller 110, a feature plane storage 120, a coefficient storage 130, a calculation circuit 140, and a distribution unit 150. Note that the processing apparatus 100 may include a plurality of calculation circuits 140 for parallel processing. The number of other processing units is not limited to one. Each of the units can be implemented by, for example, a hardware circuit such as a sequencer, an ASIC, or an FPGA. Also, a processing unit such as the controller 110 may be implemented by a CPU. Also, the processing apparatus 100 further includes a control parameter memory 111.

The controller 110 controls the overall operation of the processing apparatus 100. More specifically, the controller 110 can control the feature plane storage 120, the coefficient storage 130, and the calculation circuit 140 (to be described later). When calculating feature plane data for a feature plane, the controller 110 controls these processing units to perform an operation according to control parameters corresponding to a feature plane group to which a feature plane belongs.

The control parameter memory 111 is a memory that stores control parameters. The control parameter memory 111 can temporarily hold control parameters input from the outside of the processing apparatus 100. In this embodiment, the control parameter memory 111 stores common control parameters for each feature plane group. The feature plane group is obtained by putting a plurality of feature planes for which a feature plane to be referred to in operation processing for calculating feature plane data is common into a group based on commonality of operation processing. Details of feature plane groups will be described later. In this embodiment, the controller 110 includes the control parameter memory 111. The control parameter memory 111 can be a memory such as a DRAM or an SRAM.

The feature plane storage 120 holds feature plane data. The feature plane storage 120 can temporarily hold image data input from the outside of the processing apparatus 100 and feature plane data obtained by convolution operation processing by the calculation circuit 140. In this embodiment, the feature plane storage 120 includes a feature plane memory 121 that is a memory such as a DRAM or an SRAM for storing feature plane data. Also, the feature plane storage 120 supplies the feature plane data to the calculation circuit 140.

The coefficient storage 130 holds a weight coefficient (often called simply a weight). The coefficient storage 130 can temporarily hold a weight coefficient that is input from the outside of the processing apparatus 100 and is to be used for convolution operation processing. The coefficient storage 130 may include a memory such as a DRAM or an SRAM for storing the weight coefficients. Also, the coefficient storage 130 supplies the weight coefficients to the calculation circuit 140.

The calculation circuit 140 performs convolution operation processing using weight coefficients for feature plane data. That is, the calculation circuit 140 can perform convolution operation processing using weight coefficients supplied from the coefficient storage 130 for feature plane data supplied from the feature plane storage 120. The calculation circuit 140 can include, for example, a product-sum operation circuit for convolution operation processing.

The calculation circuit 140 performs the convolution operation for each pixel of a processing target feature plane, thereby calculating feature plane data of the processing target feature plane. In addition, the feature plane storage 120 and the coefficient storage 130 sequentially supply feature plane data and weight coefficients to the calculation circuit 140 in accordance with the processing order of the convolution operation performed by the calculation circuit 140. In this embodiment, the controller 110 controls the calculation circuit 140 such that the calculation circuit 140 performs the convolution operation in accordance with the control parameters stored in the control parameter memory 111. Also, the controller 110 controls, in accordance with the control parameters stored in the control parameter memory 111, the operations of the feature plane storage 120 and the coefficient storage 130 supplying the feature plane data and the weight coefficients to the calculation circuit 140. The feature plane storage 120 can hold the thus calculated feature plane data of the processing target feature plane.

Note that the processing to be performed by the calculation circuit 140 is not limited to convolution operation processing. For example, the calculation circuit 140 can perform another operation processing such as pooling processing or activation processing. The controller 110 can control the type of operation processing to be performed by the calculation circuit 140. For example, the controller 110 can control the calculation circuit 140 such that specific operation processing is performed to calculate feature plane data for a specific feature plane in accordance with the control parameters stored in the control parameter memory 111.

The distribution unit 150 distributes data input from the outside of the processing apparatus 100 to the units of the processing apparatus 100. For example, the distribution unit 150 can supply an input control parameter to the control parameter memory 111. Also, the distribution unit 150 can supply input image data as feature plane data to the feature plane storage 120. In addition, the distribution unit 150 can supply an input weight coefficient to the coefficient storage 130. Furthermore, the distribution unit 150 can output feature plane data obtained by convolution operation processing and held in the feature plane storage 120 to the outside of the processing apparatus 100.

### (Neural Network)

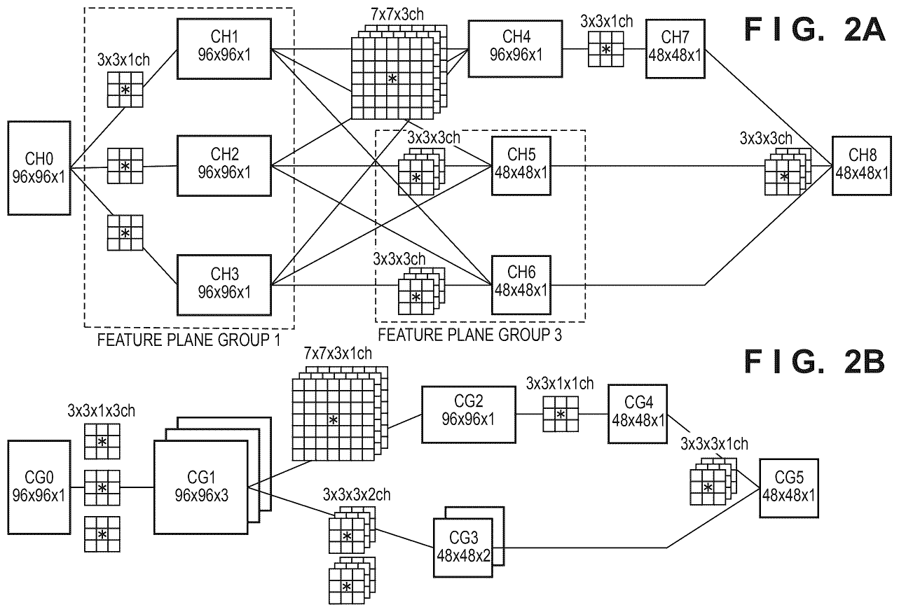

The processing apparatus according to this embodiment can perform operation processing in a neural network. An example of the neural network will be described with reference to FIG. 2A. The neural network includes a plurality of feature planes that are hierarchically connected. For example, the neural network shown in FIG. 2A includes feature planes CH0 to CH8. The feature planes are connected, as indicated by solid lines. Here, the feature plane CH0 is an input feature plane and corresponds to processing target image data input to the processing apparatus 100. Also, the feature plane CH8 is an output feature plane and corresponds to the result of operation processing in the neural network, which is output from the processing apparatus 100.

Also, in the neural network, weight coefficients (also called filter coefficients or kernels) to be used for convolution processing (also called filter processing) are also hierarchically connected. In processing in the neural network, convolution processing using feature data and weight coefficients decided by learning is performed for each spatial part (window). Convolution processing is a product-sum operation and includes a plurality of multiplication processes and cumulative addition processes. By a convolution operation for the feature data of a feature plane, the feature data of a connected feature plane is calculated. In the example shown in FIG. 2A, with a convolution operation using 3×3×1ch weight coefficients for the feature data of the feature plane CH0, the feature data of the feature plane CH1 is calculated. Also, with a convolution operation using 7×7×3ch weight coefficients for each of the feature data of a plurality of feature planes CH1 to CH3, the feature data of the feature plane CH4 is calculated. The convolution operation can be performed in accordance with, for example, equation (1) to be described later.

Additionally, in processing in the neural network, pooling processing can be performed. Pooling processing is processing of outputting a representative value (a maximum value, a minimum value, an average value, or the like) for each spatial part (window). A stride is a parameter in the pooling processing and indicates the moving width of a window. If the stride is 2, a feature image is reduced to a half size in each of the vertical direction and the horizontal direction by pooling processing. In the example shown in FIG. 2A, by a convolution operation and pooling processing for the feature data of the feature plane CH4, the feature data of the feature plane CH7 is calculated.

Note that the plurality of feature planes are classified into a plurality of layers in accordance with the connection relationship. In the example shown in FIG. 2A, the feature plane CH0 is classified into layer 0, the feature planes CH1 to CH3 are classified into layer 1, the feature planes CH4 to CH6 are classified into layer 2, the feature plane CH7 is classified into layer 3, and the feature plane CH8 is classified into layer 4. In the example shown in FIG. 2A, a plurality of feature planes (for example, the feature planes CH1 to CH3) may correspond to a plurality of channels. Note that in the following description, the feature plane data of each feature plane is data of one channel. The neural network may include connection between feature planes to skip a layer. For example, in the example shown in FIG. 2A, connection between the feature plane CH5 and the feature plane CH8 skips layer 3.

The network structure of the neural network as shown in FIG. 2A can be indicated by network information. The network information can include the connection relationship between the feature planes, the filter sizes, the bit widths of the weight coefficients, the sizes of the feature planes, and the bit widths of feature plane data.

Equation (1) indicates an example of a formula for convolution processing.

$${O}_{i , j} ( n ) = {\sum }_{m} {\sum }_{x = 0}^{X - 1} {\sum }_{y = 0}^{Y - 1} ( {I}_{i - \frac{X - 1}{2} + x , j - \frac{Y - 1}{2} + y} ( m ) \times {C}_{x , y} ( m , n ) ) \qquad ( 1 )$$

In equation (1), a variable n is the number of a processing target feature plane. A variable m is the number of a reference feature plane. Here, the processing target feature plane indicates the feature plane of a feature plane data calculation target. Also, the reference feature plane indicates a feature plane to be referred to for calculation of the feature plane data of the processing target feature plane. For example, in the example shown in FIG. 2A, if the processing target feature plane is CH5, reference feature planes are CH1, CH2, and CH3. Ia.b (m) indicates the feature plane data, at coordinates (a, b), of an mth feature plane. The window size used in convolution processing is X×Y. There exist X×Y weight coefficients (C_{0,0} (m, n) to C_{X-1,Y-1} (m, n)), and these may change for each combination of the numbers m and n of feature planes. O_{i,j}(n) is a product-sum operation result for a pixel (i, j). Variables i and j indicate the coordinates of a pixel on a feature plane. x and y indicate a relative pixel position in a window of convolution processing (or filter processing).

The feature plane storage 120 and the coefficient storage 130 sequentially supply feature plane data and weight coefficients to be used for convolution processing to the calculation circuit 140 in accordance with the processing order of the convolution operation performed by the calculation circuit 140. As described above, the controller 110 controls the operations of the feature plane storage 120, the coefficient storage 130, and the calculation circuit 140 in accordance with the control parameters.

### (Control Parameters)

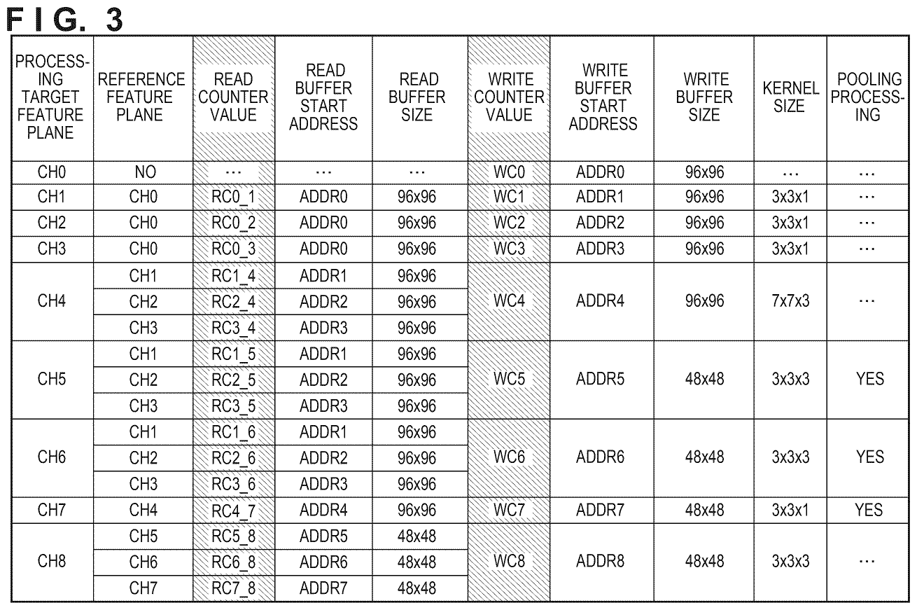

FIG. 3 shows an example of control parameters. FIG. 3 shows an example in a case where the control parameters are set for each processing target feature plane. The control parameters can include, for each processing target feature plane, a read buffer start address, a read buffer size, a write buffer start address, a write buffer size, and a kernel size. Also, the control parameters can include identification information of each processing target feature plane, identification information of each reference feature plane, and information indicating presence/absence of pooling processing.

The identification information of a processing target feature plane is information that specifies the processing target feature plane. The identification information of a reference feature plane is information that specifies a feature plane to be referred to for calculation of the feature plane data of a processing target feature plane. A read buffer start address indicates the start address of a memory area in the feature plane memory 121 where the feature plane data of a reference feature plane is stored. A read buffer size indicates the size of the memory area in the feature plane memory 121 where the feature plane data of the reference feature plane is stored. The read buffer start address and the read buffer size thus specify the memory area in the feature plane memory 121 where the feature plane data of the reference feature plane is stored. The controller 110 can set the read buffer start address and the read buffer size in a register provided in the feature plane storage 120. To calculate the feature plane data of the processing target feature plane, the feature plane storage 120 can sequentially supply the feature plane data of the reference feature plane stored in the feature plane memory 121 to the calculation circuit 140 in accordance with the information set in the register.

Note that the register provided in the feature plane storage 120 can store a read counter value for each reference feature plane. FIG. 3 shows a read counter value corresponding to each reference feature plane for the sake of reference. The feature plane storage 120 can specify the read position of feature plane data to be supplied to the calculation circuit 140 in accordance with the read buffer start address and the read counter value. That is, the feature plane storage 120 can sequentially supply the feature plane data of a reference feature plane stored in the feature plane memory 121 to the calculation circuit 140 while incrementing the read counter value.

A write buffer start address indicates the start address of a memory area in the feature plane memory 121 where the feature plane data of a processing target feature plane is stored. A write buffer size indicates the size of the memory area in the feature plane memory 121 where the feature plane data of the processing target feature plane is stored. The write buffer start address and the write buffer size thus specify the memory area in the feature plane memory 121 where the feature plane data of the processing target feature plane is stored. The controller 110 can set the write buffer start address and the write buffer size in a register provided in the feature plane storage 120. The feature plane storage 120 can sequentially store the feature plane data of the processing target feature plane, which is calculated by operation processing of the controller 110 and supplied from the controller 110 to the feature plane storage 120, in the feature plane memory 121 in accordance with the information set in the register.

Note that the register provided in the feature plane storage 120 can store a write counter value for each processing target feature plane. FIG. 3 shows a write counter value corresponding to each processing target feature plane for the sake of reference. The feature plane storage 120 can specify the write position of feature plane data supplied from the calculation circuit 140 in accordance with the write buffer start address and the write counter value. That is, the feature plane storage 120 can sequentially store, in the feature plane memory 121, the feature plane data of a processing target feature plane supplied from the calculation circuit 140 while incrementing the write counter value. Note that in the example shown in FIG. 3, the write buffer start address for a reference feature plane matches the read buffer start address for a processing target feature plane. For this reason, when performing operation processing for a processing target feature plane, the feature plane storage 120 can supply the previously calculated feature plane data of the reference feature plane to the calculation circuit 140

A kernel size indicates the size of a window in convolution processing and indicates the number of weight coefficients used in convolution processing. The controller 110 can set a kernel size and information for identifying a processing target feature plane in a register provided in the coefficient storage 130. To calculate the feature plane data of the processing target feature plane, the feature plane storage 120 can sequentially supply the weight coefficients stored in the coefficient storage 130 to the calculation circuit 140 in accordance with the information set in the register.

Information indicating the presence/absence of pooling processing specifies whether the controller 110 performs pooling processing in addition to convolution operation processing. The controller 110 can specify a kernel size and information indicating the presence/absence of pooling processing in a register provided in the calculation circuit 140. The calculation circuit 140 performs, in accordance with the information set in the register, convolution operation processing using the feature plane data of a processing target feature plane supplied from the feature plane storage 120 and filter coefficients supplied from the coefficient storage 130. Also, the calculation circuit 140 further performs pooling processing in accordance with the information set in the register or does not. The calculation circuit 140 thus calculates the feature plane data of the processing target feature plane and sequentially supplies the calculated feature plane data to the feature plane storage 120. Note that in accordance with the information indicating the presence/absence of pooling processing, the feature plane data supply operation by the feature plane storage 120 may be controlled such that a window moves in accordance with a stride.

In a case of an operation according to the control parameters shown in FIG. 3, when changing the processing target feature plane, the controller 110 can set the registers of the feature plane storage 120, the coefficient storage 130, and the calculation circuit 140 in accordance with the control parameters corresponding to the processing target feature plane.

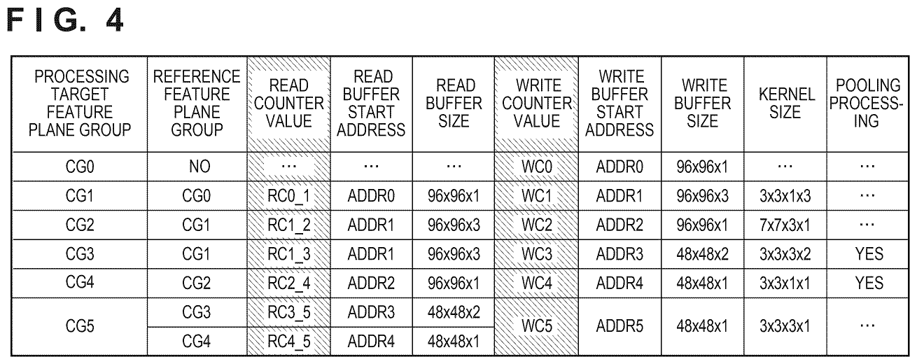

On the other hand, in this embodiment, the control parameter memory 111 stores common control parameters for each feature plane group. The embodiment will be described with reference to FIG. 4. FIG. 4 shows an example of control parameters according to this embodiment. The control parameters can include, for each processing target feature plane group, a read buffer start address, a read buffer size, a write buffer start address, a write buffer size, and a kernel size. Also, the control parameters can include, for each processing target feature plane group, identification information of each processing target feature plane group, identification information of each reference feature plane group, and information indicating presence/absence of pooling processing. Thus, the control parameters corresponding to a feature plane group to which a feature plane belongs can include information that specifies a feature plane to be referred to for calculation of the feature plane data of the feature plane. The significances of the control parameters are as described above. Here, the processing target feature plane group indicates the feature plane group of a feature plane data calculation target. Also, the reference feature plane group indicates a feature plane group to be referred to for calculation of the feature plane data of the processing target feature plane.

The control parameters corresponding to a feature plane group to which a feature plane belongs can indicate a memory area where feature plane data that the feature plane storage 120 supplies to the controller 110 to calculate the feature plane data for the feature plane is stored. In the example shown in FIG. 4, as information indicating the memory area, a read buffer start address and a read buffer size are set for each processing target feature plane group.

In addition, the control parameters corresponding to a feature plane group to which a feature plane belongs can indicate a memory area where the feature plane data for the feature plane calculated by the controller 110 is stored. In the example shown in FIG. 4, as information indicating the memory area, a write buffer start address and a write buffer size are set for each processing target feature plane group. That is, in this example, the feature plane storage 120 stores feature plane data for two or more feature planes belonging to a feature plane group in continuous memory areas of the control parameter memory 111. For this reason, as indicated by the rows of processing target feature plane groups CG2 and CG3 in FIG. 4, when performing operation processing for one processing target feature plane group, the feature plane storage 120 can use one read counter and one write counter. Thus, the register provided in the feature plane storage 120 can stores a read counter value for each reference feature plane group. Also, the register provided in the feature plane storage 120 can store a write counter value for each processing target feature plane group.

Also, the control parameters corresponding to a feature plane group to which a feature plane belongs can indicate processing that the feature plane storage 120 performs to calculate the feature plane data for the feature plane. In addition, the control parameters corresponding to a feature plane group to which a feature plane belongs can indicate the filter size of the convolution operation that the feature plane storage 120 performs to calculate the feature plane data for the feature plane. In the example shown in FIG. 4, as information indicating processing, information indicating the presence/absence of pooling processing and a kernel size are set for each processing target feature plane group.

As described above, the feature plane group is obtained by grouping multiple feature planes—each of which refers to the same feature plane during the operation that calculates feature plane data—based on the commonality of that operation. For example, in the example shown in FIG. 2A, in operation processing for calculating the feature planes of the feature planes CH1 to CH3, there is a reference to common feature plane CH0. Also, the operation processing for calculating the feature planes of the feature planes CH1 to CH3 is a convolution operation using 3×3×1ch weight coefficients and does not include pooling processing. Thus, the operation processing for calculating the feature planes of the feature planes CH1 to CH3 is common. For this reason, the feature planes CH1 to CH3 are put into a feature plane group CG1.

On the other hand, in operation processing for calculating the feature planes of the feature planes CH4 to CH6, there is a reference to common feature planes CH1 to CH3. However, the operation processing for calculating the feature plane of the feature plane CH4 is a convolution operation using 7×7×3ch weight coefficients and does not include pooling processing. On the other hand, the operation processing for calculating the feature planes of the feature planes CH5 and CH6 is a convolution operation using 3×3×3ch weight coefficients and includes pooling processing. Thus, the operation processing for calculating the feature planes of the feature planes CH5 and CH6 is common and is different from the operation processing for calculating the feature plane of the feature plane CH4. For this reason, the feature planes CH5 and CH6 are put into the feature plane group CG3. On the other hand, the feature plane CH4 is not put into the same group as the feature planes CH5 and CH6 and solely forms the feature plane group CG2.

In addition, for the feature plane CH7, another feature plane for which the feature plane to be referred to in operation processing for calculating feature plane data is common does not exist. For this reason, the feature plane CH7 is not put into the same group as the other feature planes and solely forms a feature plane group CG4.

FIG. 2B shows a neural network including the feature planes thus put into groups. At least one feature plane group can thus include two or more feature planes. Also, at least two feature planes in at least one layer may belong to different feature plane groups.

The feature plane grouping method based on commonality of operation processing is not particularly limited. For example, feature planes may be put into groups such that operation processing for calculating the feature plane data of each feature plane included in one feature plane group is common. For example, in FIG. 2B, operation processing performed to calculate the feature plane data of the feature plane group CG1 is common, as described above. Hence, as shown in FIG. 4, common control parameters are set for the feature plane group CG1. In this configuration, time required for setting the control parameters and the data amount of the control parameters can be minimized, as will be described later.

On the other hand, operation processing for calculating the feature plane data of each feature plane included in one feature plane group need not completely common. For example, feature planes may be put into groups such that the feature planes included in one feature plane group have the same width and height. That the feature planes have the same width and height indicates that the number of convolution operations for calculating the feature plane data of the feature planes is the same. Also, feature planes may be put into groups such that at least one of a plurality of operation processes performed to calculate the feature plane data of each of feature planes included in one feature plane group is common. For example, a plurality of feature planes for which pooling processing is performed to calculate feature plane data may be put into a group. In this case, control parameters for the one feature plane group can include control parameters common to the feature planes and control parameters for each feature plane. In this configuration as well, time required for setting the control parameters and the data amount of the control parameters can be reduced.

In the example shown in FIG. 2B, to calculate the feature plane data of the feature plane groups CG1 to CG4, one feature plane group is referred to for each of these. For this reason, as shown in FIG. 4, the control parameters for each of the processing target feature plane groups CG1 to CG4 specify one reference feature plane group and specify a memory area where the feature plane data of the reference feature plane group is stored. On the other hand, to calculate the feature plane data of the feature plane group CG5, the feature plane data of the feature plane group CG3 and the feature plane group CG4 are referred to. As shown in FIG. 4, the feature plane data of the feature plane group CG3 and the feature plane group CG4 are stored in different memory areas of the feature plane memory 121. Thus, the feature plane data of the feature plane group CG5 is obtained by connecting the feature plane data of the feature plane group CG3 and the feature plane group CG4 in the channel direction. Hence, as shown in FIG. 4, the control parameters for the feature plane group CG5 specify the memory areas where the feature plane data for the feature plane group CG3 and the feature plane group CG4 are stored.

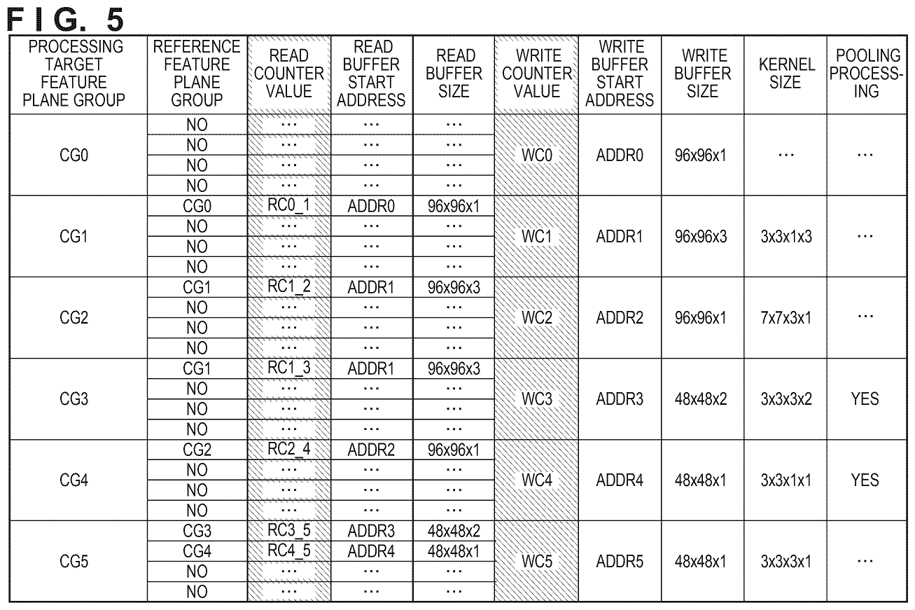

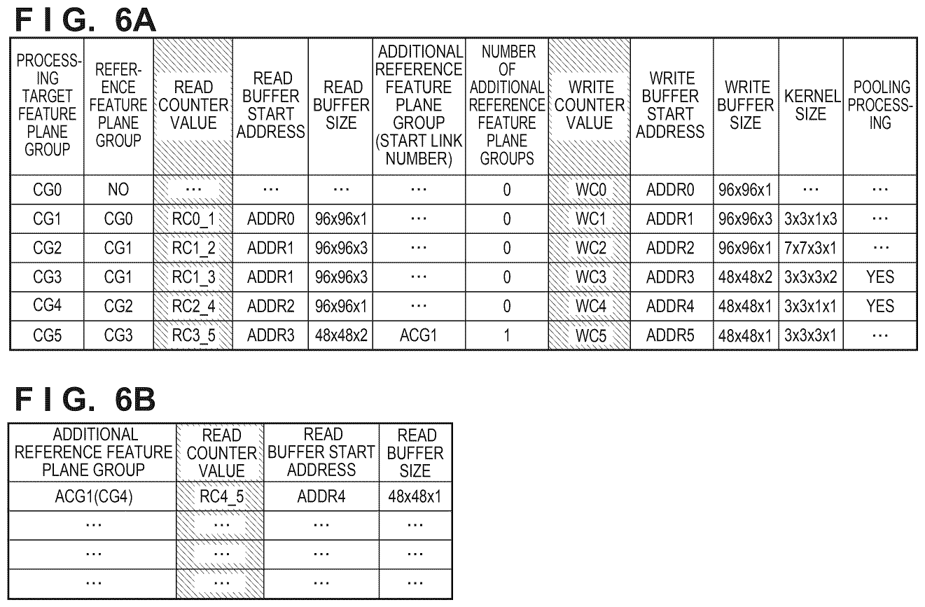

Examples of the data structure of the control parameters will be described with reference to FIGS. 5, 6A, and 6B. Control parameters shown in FIG. 5 include, for each processing target feature plane group, information that specifies four reference feature plane groups at maximum. For example, in FIG. 5, control parameters for the processing target feature plane group CG5 include the identification information of the reference feature plane groups CG3 and CG4, which specify the reference feature plane groups CG3 and CG4. In addition, the control parameters for the processing target feature plane group CG5 include information that specifies memory areas where the feature plane data of the reference feature plane groups CG3 and CG4 are stored. In this example as well, in the data structure shown in FIG. 5, information indicating the memory area to store the feature plane data of each processing target feature plane group and information indicating the contents of processing to be performed by the feature plane storage 120 are common for each processing target feature plane group. For this reason, the data amount of the control parameters can be reduced.

On the other hand, control parameters shown in FIG. 6A include, for each processing target feature plane group, information that specifies a reference feature plane group to be referred to for calculation of the feature plane data of a feature plane belonging to the processing target feature plane group. For example, in FIG. 6A, the control parameters for the processing target feature plane group CG5 include the identification information of the reference feature plane group CG3, which specifies the reference feature plane group CG3. In addition, the control parameters for the processing target feature plane group CG5 include the read buffer start address and the read buffer size of the reference feature plane group CG3. Information indicating the memory area to store these data is also information that specifies the reference feature plane group CG3. In addition, the control parameters shown in FIG. 6A include, for each processing target feature plane group, information indicating the location of information that specifies an additional reference feature plane group to be referred to for calculation of the feature plane data of the feature plane belonging to the processing target feature plane group. For example, the control parameters for the processing target feature plane group CG5 include a link number ACG1 indicating the location of information that specifies the additional reference feature plane group CG4.

The control parameter memory 111 can store the additional control parameter including information that specifies the additional reference feature plane group, in addition to the control parameters having this data structure. FIG. 6B shows an example of the data structure of additional control parameters. The control parameters shown in FIG. 6B include the read buffer start address and the read buffer size of the additional reference feature plane group CG4 in association with the link number ACG1 indicating the additional reference feature plane group. Such additional control parameters may include the identification information of the reference feature plane group CG4, which corresponds to the link number ACG1 indicating the additional reference feature plane group and specifies the additional reference feature plane group CG4.

Furthermore, as shown in FIG. 6A, the control parameters may include, for each processing target feature plane group, the number of additional reference feature plane groups to be referred to for calculation of the feature plane data of the feature plane belonging to the processing target feature plane group. In the example shown in FIG. 6A, the number of additional reference feature plane groups indicated by the control parameter for the processing target feature plane group CG5 is 1. For this reason, a record of one row started from the link number ACG1 is referred to as information that specifies the additional reference feature plane group CG4. Also, if the number of additional reference feature plane groups is 2, records of two rows started from the link number ACG1 are referred to as information that specifies the additional reference feature plane groups. According to this data structure, the data amount of the control parameters can further be reduced, and an arbitrary number of feature plane groups can be merged, as compared to the data structure shown in FIG. 5.

### Effect of the Embodiment

When the control parameters according to this embodiment are used, operation processing using the processing apparatus in the neural network can efficiently be performed. For example, the data amount of the control parameters according to this embodiment shown in FIG. 4 is smaller than that of the control parameters for each feature plane shown in FIG. 3. Hence, according to this embodiment, the data amount of the control parameters can be reduced. Also, the number of records (the number of rows) of the control parameters according to this embodiment shown in FIG. 3 is smaller than that of the control parameters shown in FIG. 4. This means that the controller 110 can decrease the number of processes for setting the registers of the feature plane storage 120, the coefficient storage 130, and the calculation circuit 140, that is, improve the operation speed.

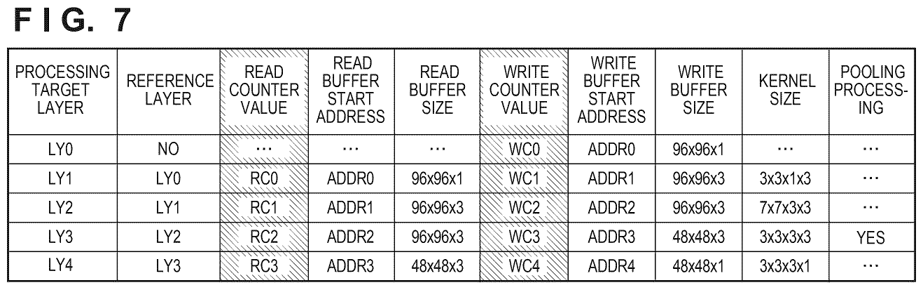

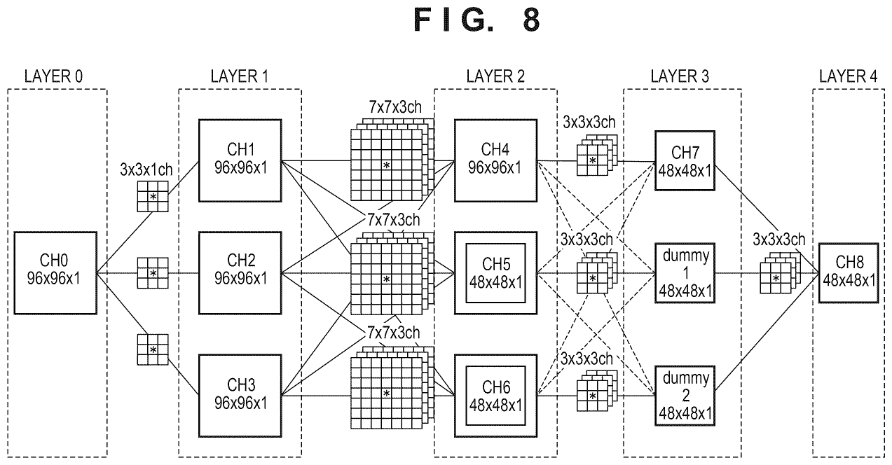

On the other hand, it can also be considered that control parameters for each layer are used. FIG. 7 shows an example of control parameters for each layer corresponding to the neural network. FIG. 8 shows the procedure of processing in the neural network according to the control parameters shown in FIG. 7. To express skip connection between the feature planes CH5 and CH6 and the feature plane CH8 using control parameters for each layer, as shown in FIG. 8, two dummy feature planes dummy1 and dummy2 are inserted into layer 3. The feature plane data of the dummy feature planes dummy1 and dummy2 are the same as the feature plane data of the feature planes CH5 and CH6. Since control parameters for each layer are used in this example, the feature plane data of the dummy feature planes dummy1 and dummy2 are calculated by convolution operation processing of 3×3×3ch, like the feature plane CH7. Here, weight coefficients are selected such that the feature plane data of the dummy feature planes dummy1 and dummy2 are the same as the feature plane data of the feature planes CH5 and CH6. Similarly, the feature plane data of the feature planes CH5 and CH6 are calculated by convolution operation processing of 7×7×3ch, like the feature plane CH4. If control parameters for each layer are used, the convolution operation amount increases as compared to a case where the feature planes are put into a group, as shown in FIG. 3.

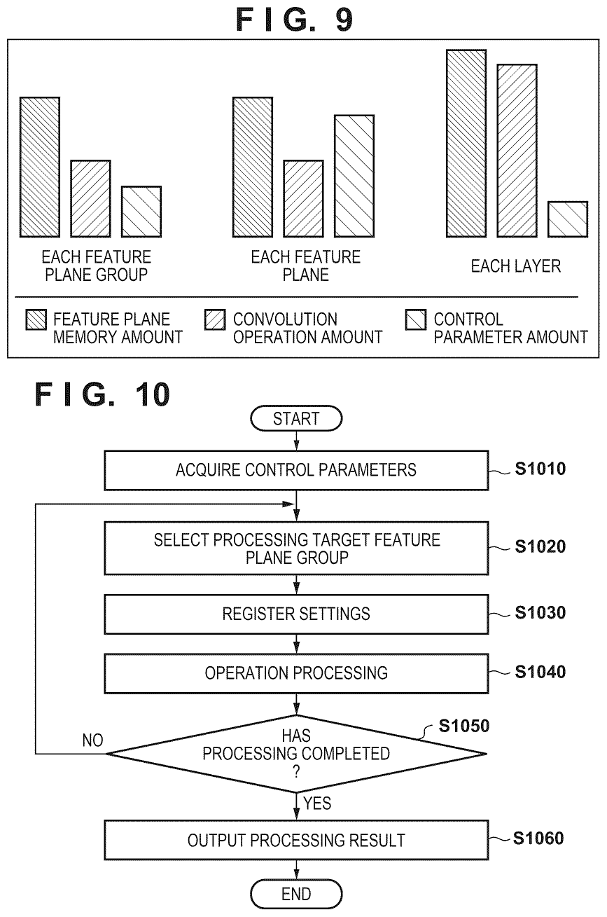

FIG. 9 shows an example of resource amounts used by the processing apparatus 100 in a case where control parameters for each feature plane group are used, in a case where control parameters for each feature plane are used, and in a case where control parameters for each layer are used. In FIG. 9, the amount of a memory for storing the feature plane data of feature planes, a convolution operation amount, and a control parameter amount in processing in the neural network are compared between the cases. When control parameters for each feature plane group are used, as in this embodiment, the convolution operation amount and the control parameter amount can simultaneously be decreased, and the feature plane memory amount can also be suppressed. It is therefore possible to efficiently perform operation processing in the neural network.

### (Processing Method)

An example of an operation method of the processing apparatus 100 will be described with reference to the flowchart of FIG. 10.

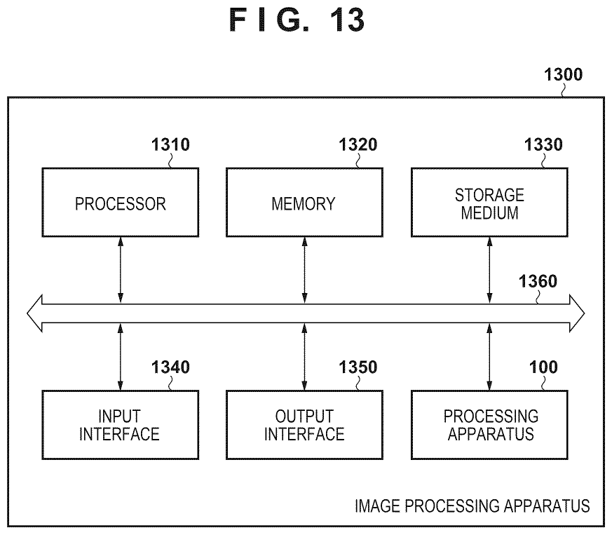

In step S1010, the distribution unit 150 acquires control parameters from the outside and stores these in the control parameter memory 111. The control parameters are manually set or automatically generated in advance in accordance with the structure of the neural network. For example, the distribution unit 150 may acquire the control parameters from a memory 1320 provided in an image processing apparatus 1300 shown in FIG. 13.

In step S1020, the controller 110 selects a processing target feature plane group in accordance with the control parameters. The controller 110 may select the processing target feature plane group in the order of the feature plane group number indicated by a control parameter.

In step S1030, the controller 110 sets the registers of the feature plane storage 120, the coefficient storage 130, and the calculation circuit 140 in accordance with the control parameters for the processing target feature plane group, as described above. In this embodiment, the controller 110 can thus set the registers every time the processing target feature plane group changes. Note that as shown in FIGS. 6A and 6B, if an additional reference feature plane group is set, the controller 110 may set the register of the feature plane storage 120 such that the feature plane data for both the reference feature plane group and the additional reference feature plane group can be read out. On the other hand, the controller 110 may sequentially do a setting for reading out the feature plane data of the reference feature plane group and a setting for reading out the feature plane data of the additional reference feature plane group for the register of the feature plane storage 120 in accordance with the progress of operation processing.

In step S1040, the feature plane storage 120, the coefficient storage 130, and the calculation circuit 140 perform processing in accordance with the information set in the registers, as described above. The feature plane data of the processing target feature plane group is thus calculated. The result of the operation processing is stored in the feature plane memory 121 in accordance with the information set in the registers, as described above. Note that if the processing target feature plane group is CG0, the feature plane storage 120 stores image data transmitted from the distribution unit 150 as the feature plane data of the feature plane group CG0 in the feature plane memory 121. The distribution unit 150 can acquire the image data from the outside and transmit it to the feature plane storage 120. For example, the distribution unit 150 may acquire the image data from the memory 1320 provided in the image processing apparatus 1300 shown in FIG. 13.

In step S1050, the controller 110 determines whether the processing for all processing target feature plane groups is completed. If the controller 110 determines that the processing is completed, the process advances to step S1060. Otherwise, the process returns to step S1020, and operation processing for the next processing target feature plane group is performed.

In step S1060, the distribution unit 150 acquires the result of operation processing stored in the feature plane memory 121. For example, the distribution unit 150 can acquire data in the memory area indicated by the write buffer start address and the write buffer size for the feature plane group CG5 as the result of processing for the input image in the neural network. The distribution unit 150 then outputs the result of the operation processing to the outside. For example, the distribution unit 150 may store the result of operation processing in the memory 1320 provided in the image processing apparatus 1300 shown in FIG. 13.

It should be noted that a case where operation processing is performed sequentially on a feature plane group basis has been described. However, the order of operation processing is not particularly limited. For example, operation processing may be performed on a line basis. In this case, in step S1020, the controller 110 can select a processing target line of a processing target feature plane group. Also, in step S1020 after the processing of steps S1030 to S1050, the controller 110 can select another processing target line of the same processing target feature plane group or a processing target line of another processing target feature plane group. The processing target line selection order can be manually set or automatically set in advance such that before the start of calculation of the feature plane data of the processing target line, calculation of feature plane data to be referred to for the calculation of the feature plane data is completed. If operation processing is performed on a line basis, the number of times of performing processing of register settings according to the control parameters in step S1030 increases, as compared to a case where operation processing is performed on a feature plane group basis. For this reason, the effect of reducing time required for setting the control parameters by using the control parameters for each feature plane group, instead of using control parameters for each feature plane, as in this embodiment, becomes larger.

### (Restriction of Feature Plane Memory)

The feature plane storage 120 may include a plurality of feature plane memories. Also, memory input/output may be restricted such that when performing convolution operation processing, feature plane data is read out from one feature plane memory provided in the feature plane storage 120 and feature plane data is written in the other feature plane memory provided in the feature plane storage 120. That is, there may exist a restriction that a memory for supplying the feature plane data of a reference feature plane group and a memory for writing the feature plane data of a processing target feature plane group are different. According to this configuration, memory input/output can easily be speeded up.

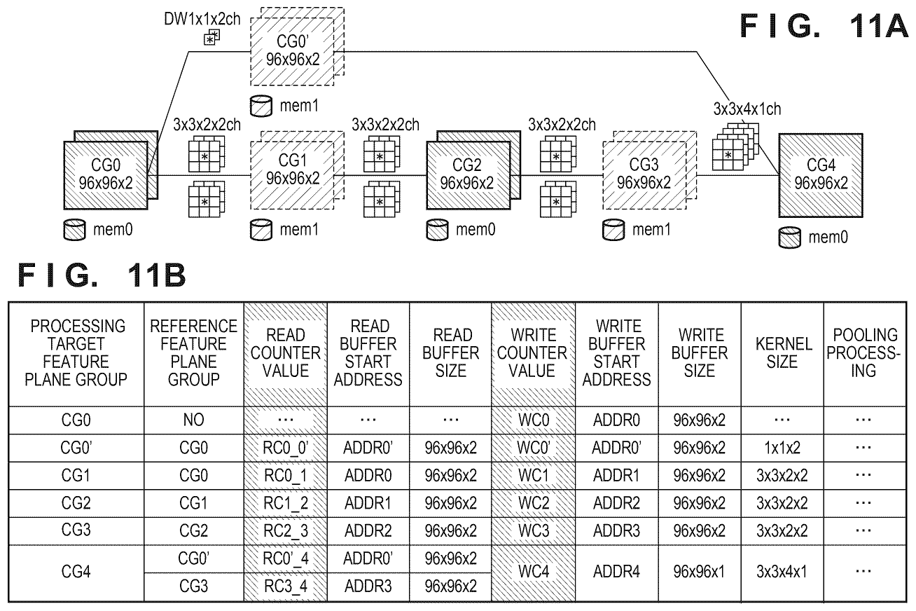

FIG. 11A describes a case where processing in a neural network shown is performed using the processing apparatus 100 having the configuration will be described. In this example, the feature plane storage 120 includes a first feature plane memory mem0 and a second feature plane memory mem1. To satisfy the above-described restriction, the feature plane data of the feature plane groups CG0, CG2, and CG4 are stored in mem0. Also, the feature plane data of the feature plane groups CG1 and CG3 are stored in mem1.

On the other hand, the feature plane group CG4 is connected to the feature plane group CG0 in addition to the feature plane group CG3. That is, to calculate the feature plane data of the feature plane group CG4, the feature plane data of the feature plane groups CG3 and CG0 are referred to. However, since both the feature plane data of the feature plane groups CG4 and CG0 are stored in mem0, the above-described restriction cannot be satisfied.

Hence, in the embodiment, a plurality of feature planes can include a first feature plane and a second feature plane connected to the first feature plane. Here, the feature plane data of the first feature plane and the feature plane data of the second feature plane are identical. In the example shown in FIG. 11A, a feature plane group CG0′ that is a copy of the feature plane group CG0 is inserted. The feature plane group CG0′ is connected to the feature plane group CG0 and further connected to the feature plane group CG4. In this case, since the feature plane data of the feature plane group CG0′ is stored in mem1, the above-described restriction can be satisfied when calculating the feature plane data of the feature plane group CG4.

FIG. 11B shows an example of control parameters for each feature plane group, which are used when performing processing in the neural network shown in FIG. 11A. As shown in FIG. 11B, the feature plane group CG0′ is calculated by convolution processing using 1×1×2ch weight coefficients. The operation amount of the convolution processing is not so large. In addition, the area size of the additional feature plane memory used to store the feature plane group CG0′ is limited to 96×96×2.

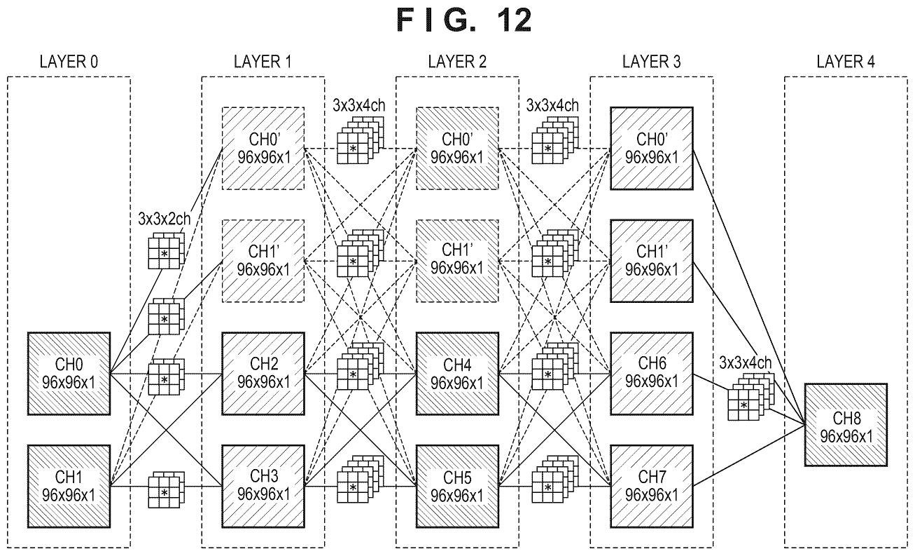

On the other hand, FIG. 12 shows the procedure of processing in the neural network using control parameters for each layer in a case where copy layers are introduced to similarly satisfy the memory input/output restriction. In this case, to use common control parameters for each layer, a copy feature plane CH0′ and a copy feature plane CH1′ need to be inserted into each of layers 1 to 3. In addition, to calculate the feature plane data of the copy feature planes CH0′ and CH1′, convolution processing using 3×3×2ch or 3×3×4ch weight coefficients is performed. Hence, an additional convolution operation amount and the area size of an additional feature plane memory derived from the insertion of the copy feature planes are considerably large.

Also, when control parameters for each feature plane are used, the data amount of the control parameters is considerably large, as described above with reference to FIG. 9. This also applies to the case where copy feature planes are inserted. Thus, using control parameters for each feature plane group, as in this embodiment, is particularly useful if there exists a memory input/output restriction.

### Use Example of Processing Apparatus

FIG. 13 is a block diagram showing an example of the configuration of the image processing apparatus 1300 according to the embodiment. In FIG. 13, a processor 1310 is, for example, a CPU and controls the operation of the entire computer. The memory 1320 is, for example, a RAM and temporarily stores programs and data. A computer-readable storage medium 1330 is, for example, a hard disk or a CD-ROM and stores programs and data for a long time. In this embodiment, a program stored in the storage medium 1330 is read out to the memory 1320. The processor 1310 then operates in accordance with the program on the memory 1320.

An input interface 1340 is an interface configured to acquire information from an external apparatus. Also, an output interface 1350 is an interface configured to output information to an external apparatus. Also, the image processing apparatus 1300 includes the above-described processing apparatus 100. The processing apparatus 100 performs operation processing for an image in a neural network. A bus 1360 connects the above-described units and enables data exchange.

In this embodiment, the processor 1310 operates in accordance with the program on the memory 1320, thereby generating a result of image processing for the image based on a processing result output from the processing apparatus 100. For example, the processor 1310 can generate a result of image processing or image recognition based on the processing result by the processing apparatus 100. In the embodiment, the processing apparatus 100 outputs a reliability map indicating likelihood of existence of a detection target object for each position or region of an input image. In this case, the processor 1310 can generate and output information indicating the position of a specific object in the image in accordance with the reliability map. For example, the processor 1310 can determine that an object exists at the peak position of values in the reliability map. The processor 1310 can then superimpose information indicating the determined position of the object on the input image.

The image processing apparatus 1300 can be implemented using a computer to which the processing apparatus 100 is connected. Examples of the computer are a general-purpose desktop computer, a laptop computer, a tablet PC, and a smartphone. At least some processing units of the image processing apparatus 1300 may be implemented by dedicated hardware. Also, the image processing apparatus 1300 may be formed by, for example, a plurality of information processing apparatuses connected via a network.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-105477, filed Jun. 28, 2024, which is hereby incorporated by reference herein in its entirety.

What is claimed is:

1. A processing apparatus that performs operation processing in a neural network in which a plurality of feature planes are hierarchically connected, the apparatus comprising:
feature plane storage that stores feature plane data;
a coefficient storage that stores weight coefficient data;
a calculation circuit that performs convolution operation processing using the stored weight coefficient on feature plane data of a feature plane that is supplied by the feature plane storage to the calculation circuit;
a parameter storage configured to store a common control parameter for each feature plane group, wherein a plurality of feature planes are grouped into the feature plane group based on commonality of operation processing such that a feature plane to be referred to in the operation processing for calculating the feature plane data of each of the plurality of feature planes is common; and
a controller configured to control the calculation circuit, the feature plane storage, and the coefficient storage to perform an operation according to the control parameter corresponding to the feature plane group to which the feature plane belongs to calculate the feature plane data of the feature plane.

2. The processing apparatus according to claim 1, wherein at least one feature plane group includes two or more feature planes.

3. The processing apparatus according to claim 1, wherein at least two feature planes in at least one layer belong to different feature plane groups.

4. The processing apparatus according to claim 1, wherein feature planes included in one feature plane group have the same width and height.

5. The processing apparatus according to claim 1, wherein at least one of a plurality of operation processes performed to calculate the feature plane data of each feature plane included in one feature plane group is common.

6. The processing apparatus according to claim 1, wherein operation processing performed to calculate the feature plane data of each feature plane included in one feature plane group is common.

7. The processing apparatus according to claim 1, wherein a control parameter corresponding to the feature plane group to which the feature plane belongs includes information that specifies a feature plane to be referred to for calculation of feature plane data of the feature plane.

8. The processing apparatus according to claim 1, wherein a control parameter corresponding to the feature plane group to which the feature plane belongs indicates a memory area that stores feature plane data that the feature plane storage supplies to the calculation circuit to calculate feature plane data of the feature plane.

9. The processing apparatus according to claim 1, wherein a control parameter corresponding to the feature plane group to which the feature plane belongs indicates a memory area in which feature plane data of the feature plane calculated by the calculation circuit is written.

10. The processing apparatus according to claim 1, wherein a control parameter corresponding to the feature plane group to which the feature plane belongs indicates processing that the calculation circuit performs to calculate feature plane data of the feature plane.

11. The processing apparatus according to claim 1, wherein a control parameter corresponding to the feature plane group to which the feature plane belongs indicates a filter size of a convolution operation that the calculation circuit performs to calculate feature plane data of the feature plane.

12. The processing apparatus according to claim 1, wherein the feature plane storage stores, in a continuous memory area, feature plane data of two or more feature planes belonging to the feature plane group.

13. The processing apparatus according to claim 1, wherein a control parameter corresponding to the feature plane group to which the feature plane belongs includes information indicating a first feature plane to be referred to for calculation of feature plane data of the feature plane, and information indicating location of information indicating a second feature plane to be referred to for calculation of the feature plane data of the feature plane.

14. The processing apparatus according to claim 13, wherein the parameter storage stores an additional control parameter including information indicating a memory area that stores feature plane data of the second feature plane, in addition to the control parameter.

15. The processing apparatus according to claim 1, wherein
the feature plane storage includes a first feature plane memory and a second feature plane memory, which are configured to store the feature plane data,
the plurality of feature planes include a first feature plane and a second feature plane connected to the first feature plane, wherein feature plane data of the first feature plane and feature plane data of the second feature plane are identical, and
the feature plane data of the first feature plane is stored in the first feature plane memory, and the feature plane data of the second feature plane is stored in the second feature plane memory.

16. An image processing apparatus comprising:
a processing apparatus that performs operation processing in a neural network in which a plurality of feature planes are hierarchically connected, the processing apparatus comprising:
feature plane storage that stores feature plane data;
a coefficient storage that stores weight coefficient data;
a calculation circuit that performs convolution operation processing using the stored weight coefficient on feature plane data of a feature plane that is supplied by the feature plane storage to the calculation circult;
a parameter storage configured to store a common control parameter for each feature plane group, wherein a plurality of feature planes are grouped into the feature plane group based on commonality of operation processing such that a feature plane to be referred to in the operation processing for calculating the feature plane data of each of the plurality of feature planes is common; and
a controller configured to control the calculation circuit, the feature plane storage, and the coefficient storage to perform an operation according to the control parameter corresponding to the feature plane group to which the feature plane belongs to calculate the feature plane data of the feature plane; and
a generation unit configured to generate a result of image processing for the image based on a processing result output from the processing apparatus.
